(19) United States
(12) Patent Application Publication
(10) Pub. No.: US 2007/0180389 A1
(43) Pub. Date: Aug. 2, 2007

(54) GRAPHICAL USER INTERFACE FOR ACCESSING DATA FILES

(75) Inventors: Jukka Holm, Tampere (FI); Antti Eronen, Tampere (FI); Arto Lehtiniemi, Lempaala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/345,028

(22) Filed: Jan. 31, 2006

(51) Int. Cl. G06F 3/00

(52) U.S. Cl. 715/764; 715/765; 715/810; 715/835; 715/848

(57) ABSTRACT

A method, system, electronic device, network entity and computer program product are provided for creating a game-like graphical user interface (GUI) for use when controlling data files, such as music, video or text files, either stored on or accessible by an electronic device. The data files, as well as the various functions for interacting with the data files, may be represented as a video game or playful application, wherein each game element works as an interface to a data file or folder or some specific function for interacting with and controlling the data files and folders. Game elements may be assigned based on, for example, file type (e.g., music, video or text) or, in the instance where the GUI is used for interfacing only music files, on song, artist or album name, musical genre, or a play list related to a certain topic. These elements may include for example, various objects, such as persons, vehicles and buildings, as well as their particular outlook and/or location, and various events, such as moving, driving, jumping, running, shooting, touching or collecting, to name a few.

### FIELD OF INVENTION

Exemplary embodiments of the present invention relate generally to the process of interacting with and controlling various data files accessible by an electronic device and, in particular, to a game-like graphical user interface (GUI) for use in this process.

### BACKGROUND OF THE INVENTION

People are increasingly storing and accessing more and more data files, such as audio, video, text and/or multimedia files, on their electronic devices (e.g., cellular telephones, personal digital assistants (PDAs), personal computers (PCs), and laptops). For example, many individuals store entire music collections in the form of MP3 files on their cell phones or other mobile devices. These individuals may then use some form of a music player implemented on their device to select and playback the songs from their collection.

In addition, various automatic music recommendation systems are gaining popularity, wherein these systems determine, based, for example, on a user's current music collection, or on specific information input by a user, what new albums or songs the individual may like to add to his or her collection. An example of such a music recommendation system can be found at www.pandora.com. The same popularity may likewise arise in relation to automatic video recommendation systems, as they apply to video files of various movies and/or TV shows.

Currently, however, accessing and controlling this multitude of data files can be quite tedious and somewhat boring. A need, therefore, exists for a more entertaining way of interfacing with various data files either stored on an electronic device or accessible to the electronic device over a communications network, via, for example, one of the above-described recommendation systems.

### BRIEF SUMMARY OF THE INVENTION

In general, exemplary embodiments of the present invention provide an improvement over the known prior art by, among other things, providing a game-like graphical user interface (GUI) for accessing and controlling one or more data files either stored on an electronic device, or accessible by the electronic device via a communications network, wherein in the GUI enables the user to access and control the various data files in the same manner in which he or she would execute a game.

According to one aspect of the present invention, a method is provided for creating a game-like graphical user interface for accessing and controlling one or more data files. In one exemplary embodiment, the method includes: (1) associating a game-like graphical image with respective data files; (2) associating a behavior of the game-like graphical images with a respective one of a plurality of functions for accessing and controlling the data files; and (3) enabling a user to manipulate the behavior of the game-like graphical images in order to perform the plurality of functions.

In one exemplary embodiment, the game-like graphical images are generated in response to execution of a game. In this exemplary embodiment, enabling a user to manipulate the behavior of the game-like graphical images in order to perform the plurality of functions may include enabling the user to play the game and to select the functions as a result of the game play.

In another exemplary embodiment, the method may further include displaying the game-like graphical images associated with respective data files. In addition, the method may include displaying an avatar image representing the user, and enabling the user to manipulate the behavior of the avatar image in order to manipulate the behavior of the game-like graphical images associated with respective data files.

According to another aspect of the present invention, an electronic device is provided that is capable of creating a game-like graphical user interface for accessing and controlling one or more data files. In one exemplary embodiment, the electronic device comprises an input device, a processor in communication with the input device, and a memory in communication with the processor. The memory may, in turn, store an application executable by the processor that is capable, upon execution, of: (1) associating a game-like graphical image with respective data files; (2) associating a behavior of the game-like graphical images with a respective one of a plurality of functions for accessing and controlling the data files; and (3) enabling a user to manipulate the behavior of the game-like graphical images in order to perform the plurality of functions.

According to yet another aspect of the present invention, a network entity is provided that is capable of creating a game-like graphical user interface for accessing and controlling one or more data files, wherein the network entity comprises a processor and a memory in communication with the processor. In one exemplary embodiment, the memory stores an application executable by the processor, wherein the application is capable, upon execution, of: (1) generating a recommendation of one or more media files for a user; and (2) creating a game-like graphical user interface through which the user can access and control the recommended media files.

In one exemplary embodiment, creating the game-like graphical user interface includes: (1) associating a game-like graphical image with respective data files; (2) associating a behavior of the game-like graphical images with respective functions for accessing and controlling the data files; and (3) enabling a user to manipulate the behavior of the game-like graphical images in order to perform the functions.

According to another aspect of the present invention, a system for creating a game-like graphical user interface for accessing and controlling one or more data files is provided. In one exemplary embodiment, the system includes an electronic device and a network entity accessible by the electronic device for the purpose of accessing one or more data files. The network entity may, in turn, be configured to provide the electronic device with a game-like graphical user interface through which the electronic device is capable of accessing and controlling the data files.

In one exemplary embodiment, the system further includes one or more media providers in communication with the network entity for the purpose of providing one or more data files to the network entity for accessing by the electronic device.

According to another aspect of the present invention, a computer program product for creating a game-like graphical user interface for accessing and controlling one or more data files is provided. The computer program product contains at least one computer-readable storage medium having computer-readable program code portions stored therein. The computer-readable program code portions of one exemplary embodiment include: (1) a first executable portion for associating a game-like graphical image with respective data files; (2) a second executable portion for associating a behavior of the game-like graphical images with a respective one of a plurality of functions for accessing and controlling the data files; and (3) a third executable portion for enabling a user to manipulate the behavior of the game-like graphical images in order to perform the plurality of functions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1-4, represent various screen shots of a game-like graphical user interface (GUI) generated by an electronic device, a recommendation engine or the like for accessing and controlling data files either stored on or accessible by an electronic device in accordance with exemplary embodiments of the present invention;

FIG. 5 is a block diagram of one type of system that would benefit from exemplary embodiments of the present invention;

FIG. 6 is a schematic block diagram of an entity capable of operating as a recommendation engine in accordance with exemplary embodiments of the present invention;

FIG. 7 is a schematic block diagram of a mobile station capable of operating in accordance with an exemplary embodiment of the present invention; and

FIG. 8 is a flow chart illustrating the steps which may be taken in order to create a game-like GUI for manipulating data files in accordance with exemplary embodiments of the present invention.

### DETAILED DESCRIPTION OF THE INVENTION

The present inventions will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

In general, exemplary embodiments of the present invention provide a graphical user interface (GUI) for use when controlling data files, such as music, video, text or multimedia files, or the like, either stored on an electronic device or accessible by the electronic device via, for example, a communications network.

In one exemplary embodiment, the data files, as well as the various functions for interacting with the data files are represented as a video game or playful application. At least one game element works as an interface to a data file or folder or some specific function for interacting with and controlling the data files and folders (e.g., open, close, save, delete, move to another folder, rename, etc., or, in the instance where the data files comprise music files, e.g., play, stop, pause, fast forward, rewind, skip track or shuffle).

Game elements may be assigned based on, for example, file type (e.g., music, video, text or multimedia) or, in the instance where the GUI is used for interfacing only music files, for example, on song, artist or album name, musical genre, or a play list related to a certain topic (e.g., an 80's party). Game elements may include for example, various objects, such as persons, vehicles and buildings, as well as their particular outlook and/or location, and various events, such as moving, driving, jumping, running, shooting, touching or collecting, to name a few. Visualization themes may be customized by the user, and new themes may be downloaded from the Internet.

Exemplary Game-Like GUI's:

The following provides a few examples of various game-like GUI's that may be created in accordance with exemplary embodiments of the present invention for accessing various data files. As one of ordinary skill in the art will recognize, the following is provided for exemplary purposes only and should not be taken in any way as limiting the scope of the present invention.

Accessing Music Files Stored on an Electronic Device Via a Music Player:

Exemplary embodiments of the present invention may be used to create a game-like GUI for use when controlling various music files stored on a user's electronic device (i.e., as part of the user's music collection). In one exemplary embodiment, the game may be a virtual world, such as a city consisting of numerous suburbs, buildings, vehicles, bars, people, and so on. Each city element may provide an interface to a particular song or album within the user's music collection or some specific music player function. A description of what each graphical element represents (e.g., the musical genre, artist and/or song title) may be displayed to the user, where the user elects to have this feature enabled. The player may control an avatar (i.e., a graphical image representing the user or player) that can interact with different game elements by, for example, moving, shooting, touching and/or collecting items.

In one exemplary embodiment, each suburb of the city may represent a certain musical genre. For example, a ghetto may represent hip hop music; a Latin Quarter, South American music; a country side, country music; and China Town, Eastern music. In order to access music files in the various musical genres, the user or player may navigate his or her avatar to these different suburbs.

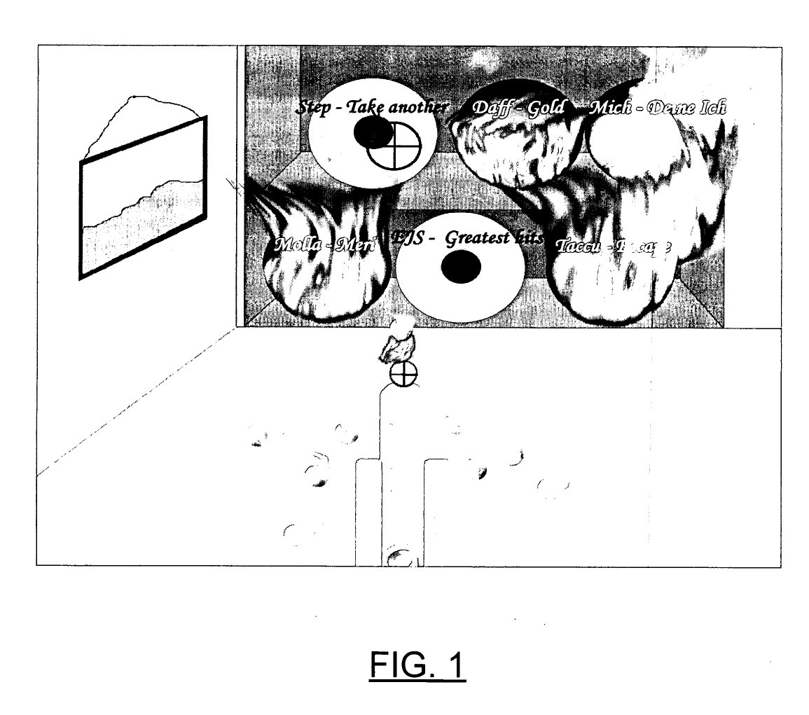

In another exemplary embodiment, the city may include various bars or discotheques, wherein each bar or discotheque represents a different musical genre. In this exemplary embodiment, requesting a song from a DJ within a particular bar or discotheque may function to play that song. Alternatively, as illustrated in the screenshot of FIG. 1, shooting a particular record may cause that audio file to be deleted from the folder. Album covers, song lyrics, pictures of artists, and the like, may be projected on the walls of the bar while the song is being played. If at some point the user decides to delete an entire folder, for example because he or she no longer likes country music, the user could, for example, cause his or her avatar to burn down the entire country bar.

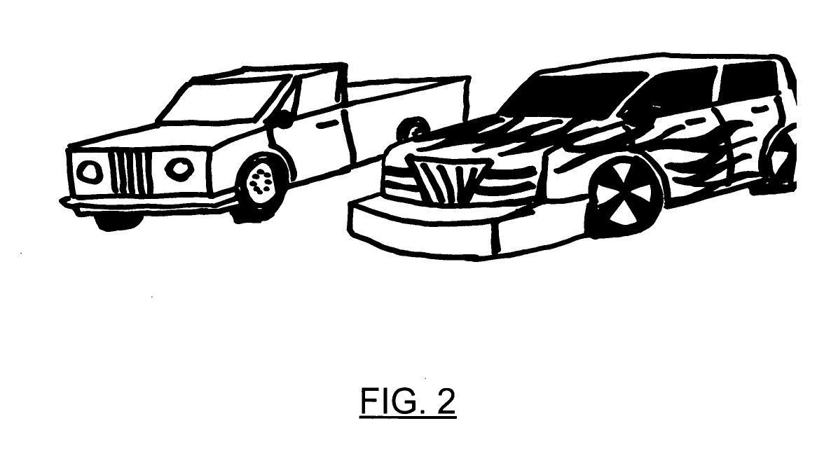

In yet another exemplary embodiment, different types of cars in the city may likewise represent different musical genres or play lists (i.e., sub-collections of music the user him or herself has created, such as a collection of 70's music). For example, an old mustang may represent classic rock, while a pimped-up low-rider may represent hip-hop music. In this example, turning on the car and selecting a radio station may play a particular song, driving the car faster may fast forward the song currently being played, and putting the car in reverse may rewind it. FIG. 2 provides an exemplary screen shot of a game-like graphical user interface in accordance with this exemplary embodiment. In particular, FIG. 2 illustrates a couple of cars sitting in a parking lot. One car, which is illustrated as a pick-up truck, represents a particular country artist and his album, while the second car represents a hip-hop artist.

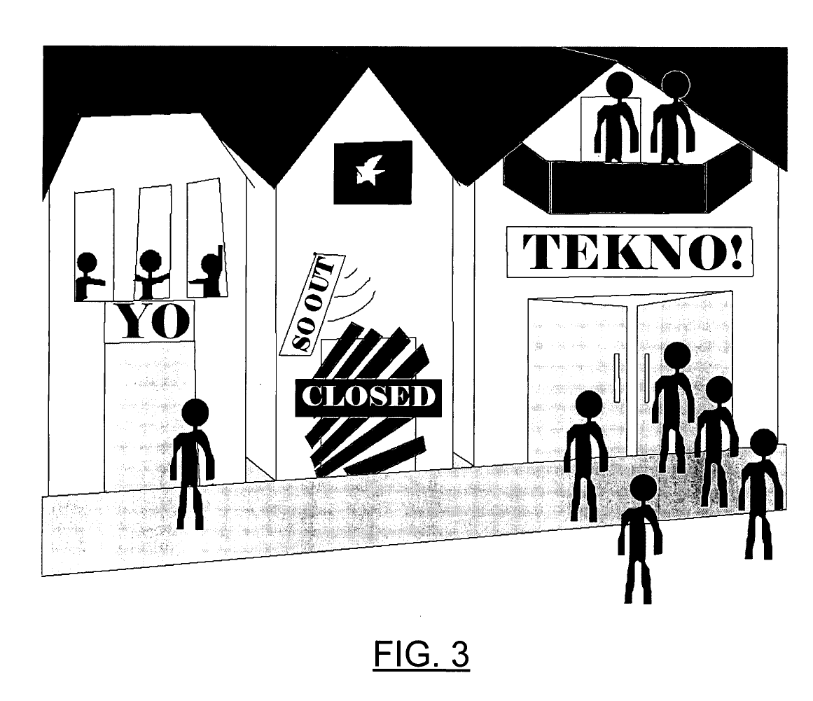

In any of the above exemplary embodiments, the game world may also be dynamic, with old buildings or beat up cars representing rarely listened to songs or song genres, and new buildings or cars representing recently accessed or downloaded music types. This exemplary embodiment is illustrated in the screen shot of FIG. 3, which illustrates three buildings that each represents a different musical category. As shown, the building in the center looks abandoned, and displays a sign indicating that the bar is closed. This may signify that the user has not listened to the music associated with the graphical image of that building in a while. By contrast, the two other buildings illustrated are in good shape, signifying that that the user has been listening to the music they represent fairly frequently.

In this scenario, the gaming program (i.e., the application capable of assigning game elements to various music files and functions for interacting with the music files, and of enabling the user of the electronic device to manipulate the various game elements in order to effect the respective functions) may be stored exclusively in memory on the electronic device. The user may, therefore, user the game-like GUI in order to control his or her music files regardless of whether he or she is currently connected to a communications network.

Accessing a Network Entity to Download Music Files to the Electronic Device:

Exemplary embodiments of the present invention may similarly be used to create a game-like GUI for use in conjunction with a network entity configured to provide access to various music files, which can be downloaded by the user to his or her electronic device. In one exemplary embodiment, the network entity may comprise a recommendation engine configured to provide recommendations for music files it has determined the user may be interested in downloading. Recommendations may be made, for example, based on previous music files downloaded by the user, or on an analysis of the user's current music collection. An example of such a recommendation engine can be found at www.pandora.com.

The game of this scenario may be very similar to that of the preceding scenario, with the difference being that it may be more dynamic. In particular, images in this GUI are not limited to providing interfaces to audio files stored on the user's electronic device and, instead, may represent various recommendations for new music files that can be downloaded from the network to the electronic device. These images may, therefore, change as more information is ascertained regarding the user. In one exemplary embodiment, the graphical images are provided by various record companies in association with their music files.

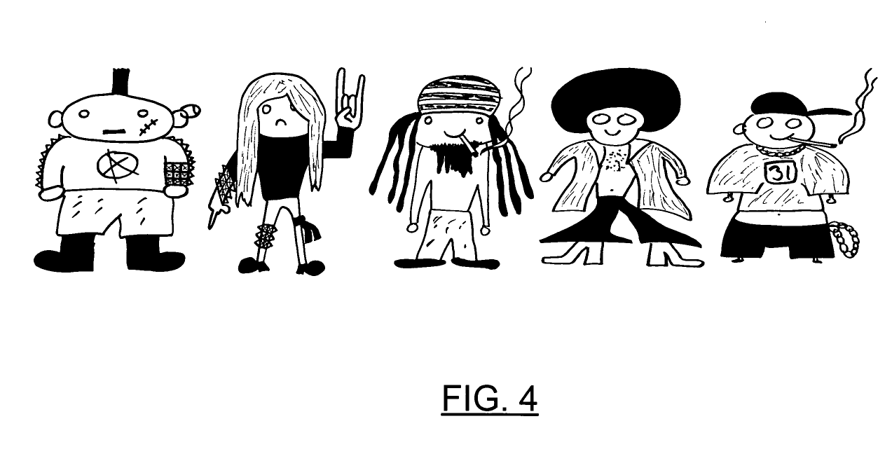

For example, as shown in the screen shot of FIG. 4, in one exemplary embodiment, different looking people walking around the city may represent recommendations for different musical genres for downloading music (e.g., policemen may represent Blues music, while Rastafarians may represent reggae music). The user may cause his or her avatar to approach a particular character causing a dialogue to being. The character may offer a recommendation for an artist, album or song title relating to the genre that character represents. The user can then preview the songs the character recommends, and, if he or she likes them, purchase them by, for example, causing his or her avatar to pay the individual. By contrast, if the user does not want to purchase the song, he or she may cause his or her avatar to shoot the recommender.

In another exemplary embodiment, new bars and/or discotheques may be built throughout the city to represent music recommendations. Old bars or discotheques representing music the user has not listened to in a long time may be torn down, and new bars or discotheques may be built in their place to represent music being recommended to the user based on his or her music preferences. The name of the bar may, for example, be “Hot New Jazz Bar.” When the user causes his or her avatar to enter the bar, he or she can preview the music being recommended. If the user likes the recommendation, he or she can cause his or her avatar to, for example, pay the waiter or bartender at the bar or discotheque to effect the purchase of that music file.

In the car example discussed above, a car shop within the city may represent the music service. In this example, test driving a car may represent listening to a portion of a song to determine whether or not to download it, and purchasing the car may cause the particular music file to be downloaded. Alternatively, or in addition, customizing a particular car by, for example, buying new equipment or getting a new paint job, may likewise cause a particular music file to be downloaded. In this scenario, the more tracks the user has purchased, the more customized the car will be.

In addition to providing recommendations based on previous music files downloaded by the user, or on an analysis of the user's current music collection, the network entity may vary its recommendations based on actions or behaviors of the user's avatar. In particular, in one exemplary embodiment, a user may manipulate the behavior of his or her avatar to indicate the desired type of recommendations the user wishes to receive. For example, if the user causes his or her avatar to shoot an album by a particular artist, this information may be taken by the network entity, or music service, as indicating that it should not make recommendations of music files by that particular artist. As another example, an aggressive gesture on the part of the user's avatar (e.g., shooting or hitting an object), may indicate to the network entity that it should recommend aggressive music, such as heavy metal or classic rock. Alternatively, a friendly gesture on the part of the avatar (e.g., petting a dog or blowing a kiss to someone) may indicate that the user wants recommendations for up beat or easy listening music. Of course, the opposite may be true, where the network entity seeks to sooth an aggressive avatar with romantic or soothing music.

In the foregoing scenario, at least a portion of the gaming program may be stored on the network entity acting as the recommendation entity. In addition, the network entity may store at least a description of the music files owned by the user. The virtual world created by the network entity may, in turn, have as its core, buildings, cars, etc. that represent the user's own collection. This core virtual world may be displayed to the user regardless of whether he or she is connected to the network for the purpose of receiving music recommendations. When the user does connect to the network entity, the network entity's musical recommendations may be represented by objects or graphical images that surround the core virtual world. In other words, when the user connects to the network, new graphical objects and recommendations may be downloaded dynamically to the core virtual world. For example, the user's own collection may be represented by a city center and the bars, cars and people in its immediate vicinity. The recommendations may then be represented by the suburbs, streets and/or countryside going away from the city center. The addition of these new recommendations/objects may be shown, for example, by new buildings rising from the ground, streets getting longer, new people arriving in a city, etc.

The network entity may further store one or more music files provided to the electronic device for downloading. Alternatively, or in addition, the network entity may be capable of accessing various media providers to acquire the various music files.

Calibrating a User's Music Collection:

Video games or playful applications may also be used for calibrating (i.e., arranging) a user's musical collection. For example, in a Tetris-type implementation, pieces or blocks that drop down may represent different music files or songs, and a user may try to drop blocks or pieces representing songs of similar types onto each other. For example, the user may categorize songs based on various attributes, such as genre, tempo, style, artist, or the like, by creating stacks of blocks, wherein the songs represented by the blocks in each stack have similar attributes. The result may be to create one or more folders of music files, wherein each folder includes songs of one of the categories.

Alternatively, a more advanced calibration method may be implemented, wherein one or more slots exist that each represents a different song attribute (e.g., fast, slow, energetic, calm, etc.). The user, instead of merely dropping blocks representing similar songs on top of one another, will drop each block into a specific slot. After the user has played the game for a certain amount of time, the system will calibrate itself (i.e., will separate the songs based on how the user has defined the various slots), thus personalizing the system. In particular, the system may be capable of assessing the attributes or characteristics of the songs placed in the various slots by the user in order to determine which attributes the user associates with respective slots. The system can then, itself, categorize the songs into the slots, or categories. The result may, therefore, be the creation of various personalized music folders. For example, if the user places multiple blocks representing songs by U2 in one slot, and multiple blocks representing songs that came out in the 1980's in another slot, the system may determine that the first slot is associated with U2, and then place all songs by U2 in that slot or folder, and that the second slot is for 80's music, and place all 80's songs in that slot or folder.

This information may also be used by the recommendation engine to provide more personalized recommendations. For example, the network entity may compare the content of the music files the user has classified in various ways (i.e., by placing them in various categories) to other music files accessible by the recommendation engine, and locate files that most likely would also be perceived as fitting in the various categories by the user.

As one of ordinary skill in the art will recognize, while each of the above scenarios was described as relating to music files, these scenarios are not so limited. By contrast, each of the above scenarios may similarly be used for accessing and receiving recommendations for other types of media or multimedia files, such as movies or TV shows. For example, in the above scenario, in which a virtual city represents the user's music collection, as well as various music recommendations, a neighboring city may likewise be generated that represents the user's video collection and/or video recommendations. If the user wants to stop listening to music and begin watching a video, he or she can cause his or her avatar to travel to the next town or city.

Accessing All Types of Files Stored on the Electronic Device:

In this scenario, the game-like GUI may be used to access all types of data files stored on the user's electronic device including, for example, all audio, video, text and multimedia files. In one exemplary embodiment, the virtual world created may, for example, be in the form of a forest or flower farm, wherein each tree or plant, or set of trees or plants, represents a different file type and each leaf or flower represents a different data file. For example, one or more trees representing music files may have note-shaped leaves representing the various music files, while trees representing video files may have leaves shaped like miniature video cameras representing the various video files.

In one exemplary embodiment, the trees within each set of trees may have additional distinguishing characteristics in order to represent sub-categories within each file type. For example, the set of trees or plants representing music files may, in addition to having note-shaped leaves, each display differing characteristics in order to represent various musical genres or artists. For example, a heavy metal tree may have a grey trunk and black leaves with wormholes, while a disco tree may be pink with colorful leaves and a blues tree may have blue leaves. In general, the user can customize these trees however he or she would like.

The user may, in one exemplary embodiment, keep the plants or trees alive by accessing the various files represented by the leaves or flowers of those plants or trees. Accessing a particular file may, for example, be represented by a bee flying to a particular flower or a worm crawling onto a particular leaf. If the user does not access the files related to a particular tree or plant, that tree or plant may begin to die. This may be shown, for example, by leaves or flowers of seldom accessed files getting brown or wilted and falling to the ground. If a user begins to access the files of the dying tree or plant with some added frequency, the tree or plant may be brought back to life. Alternatively, if the user decides that he or she no longer needs the files that are represented by a particular tree or plant, he or she can cause his or her avatar to, for example, weed the plant or tree, resulting in the corresponding files being deleted. If the user decides he or she only wants to delete specific files of a particular tree or plant, he or she may, for example, select the representative leaves or flowers and throw them away.

In one exemplary embodiment, another feature may be to vary the size of the trees or plants dependent upon the frequency with which the user accesses the files of the respective trees or plants. For example, trees representing the data files that are more frequently accessed by the user may be larger, while the trees of less frequently accessed data may be smaller.

Overall System, Recommendation Engine and Electronic Device:

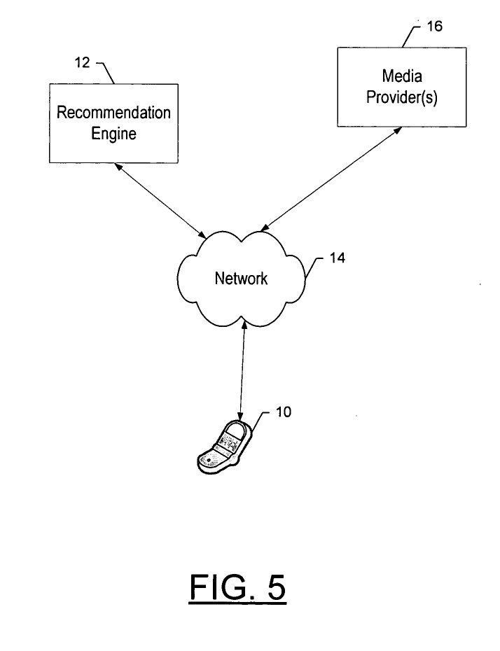

Referring to FIG. 5, an illustration of one type of system that would benefit from the present invention is provided. As shown in FIG. 1, the system may include one or more electronic devices 10 in communication with a recommendation engine 12 over a communications network 14 for the purpose of receiving recommendations for and downloading various media files (e.g., music or video files). The recommendation engine 12, as well as the electronic device 10 itself, may further be in communication with one or more media providers 16 over the same or different communications network 14 for the purpose of obtaining the media files ultimately provided to the electronic device 10. In general, therefore, the electronic device 10 of one exemplary embodiment may be capable of accessing and downloading media files from the media provider(s) 16 either directly, or via the recommendation engine 12.

As is discussed in more detail below, according to exemplary embodiments of the present invention, the electronic device 10 and the recommendation engine 12, each may store an application capable of creating a game-like GUI for use when accessing and controlling not only various data files stored on the electronic device 10, but also data files accessed by the electronic device 10 via the recommendation engine 12 and/or the media provider(s) 16.

The electronic device may comprise any wired or wireless communication device capable of storing and/or accessing various data files, such as, for example, a cellular telephone, personal digital assistant (PDA), pager, personal computer (PC), laptop, tablet, or other similar device. The communications network may comprise any wired or wireless network including, for example, a local area network (LAN), a metropolitan area network (MAN), and/or a wide area network (WAN).

The communications network may be capable of supporting communication in accordance with any one or more of a number of first-generation (1G), second-generation (2G), 2.5G and/or third-generation (3G) mobile communication protocols or the like. More particularly, one or more electronic devices may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

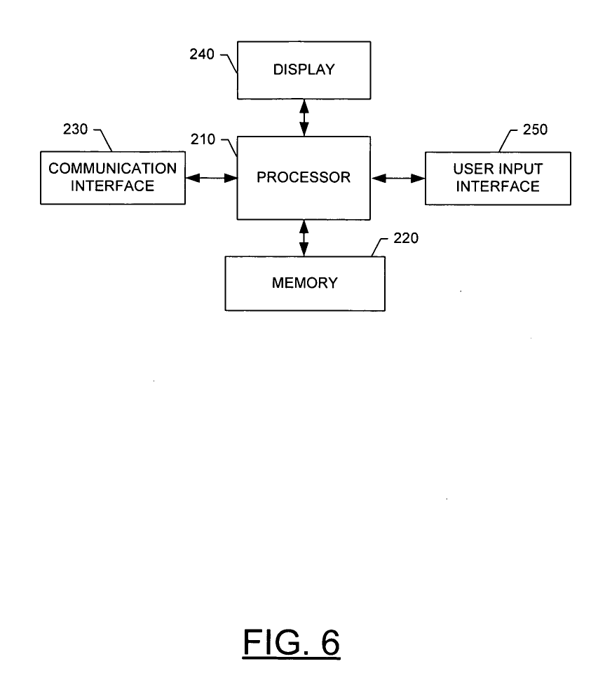

Referring now to FIG. 6, a block diagram of an entity capable of operating as a recommendation engine 12 is shown in accordance with an exemplary embodiment of the present invention. The entity capable of operating as a recommendation engine 12 may include various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a recommendation engine 12 can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

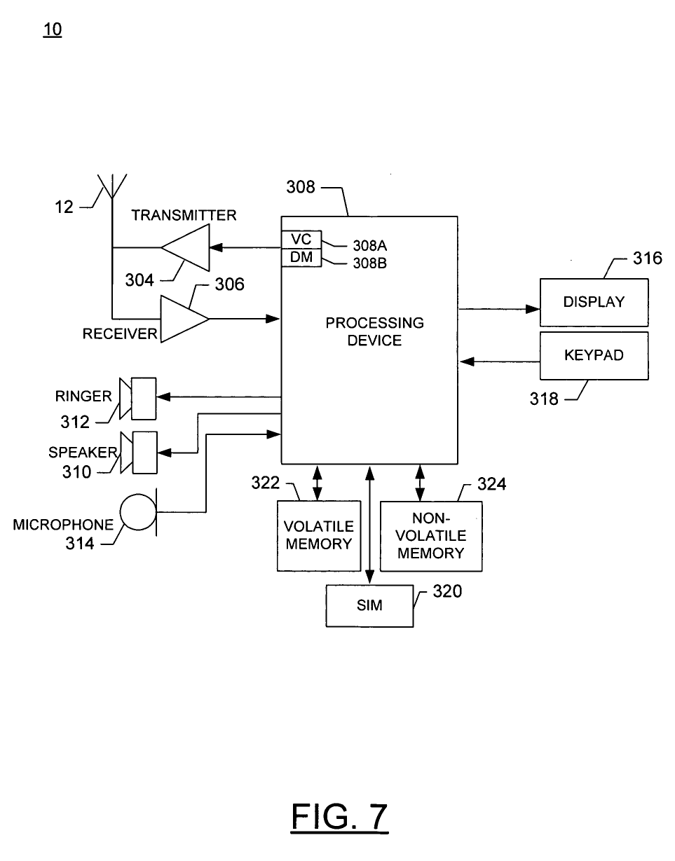

Reference is now made to FIG. 7, which illustrates one type of electronic device 10 that would benefit from embodiments of the present invention. In particular, FIG. 7 illustrates a mobile device including various means for performing one or more functions in accordance with exemplary embodiments of the present invention. It should be understood, however, that the mobile device illustrated and hereinafter described is merely illustrative of one type of electronic device that would benefit from the present invention and, therefore, should not be taken to limit the scope of the present invention. Other types of mobile devices, such as personal digital assistants (PDAs), laptop computers, as well as other types of electronic devices including both mobile, wireless devices and fixed, wireline devices, can readily employ embodiments of the present invention.

As stated above, the mobile device includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 7, in addition to an antenna 12, the mobile device 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like. Further, for example, the electronic device can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the electronic device and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile device may include a battery, such as a vibrating battery pack, for powering the various circuits that are required to operate the electronic device, as well as optionally providing mechanical vibration as a detectable output.

The mobile device can also include means, such as memory including, for example, a subscriber identity module (SIM) 320, a removable user identity module (R-UIM) (not shown), or the like, which typically stores information elements related to a mobile subscriber. In addition to the SIM, the electronic device can include other memory. In this regard, the electronic device can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for associating one or more game-like graphical images, as well as their corresponding behaviors, with various data files, also stored in the memory or otherwise accessible by the mobile device, and functions for accessing and controlling those data files, such that a user is able to manipulate the behavior of the various graphical images using, for example, one of the above-referenced input devices, in order to effect the performance of various functions with respect to the data files (e.g., play a song).

The system, method, electronic device, network entity and computer program product of exemplary embodiments of the present invention are primarily described in conjunction with mobile communications applications. It should be understood, however, that the system, method, network entity and computer program product of embodiments of the present invention can be utilized in conjunction with a variety of other applications, both in the mobile communications industries and outside of the mobile communications industries. For example, the system, method, electronic device, network entity and computer program product of exemplary embodiments of the present invention can be utilized in conjunction with wireline and/or wireless network (e.g., Internet) applications.

Method of Creating a Game-Like GUI for Accessing and Controlling Data Files:

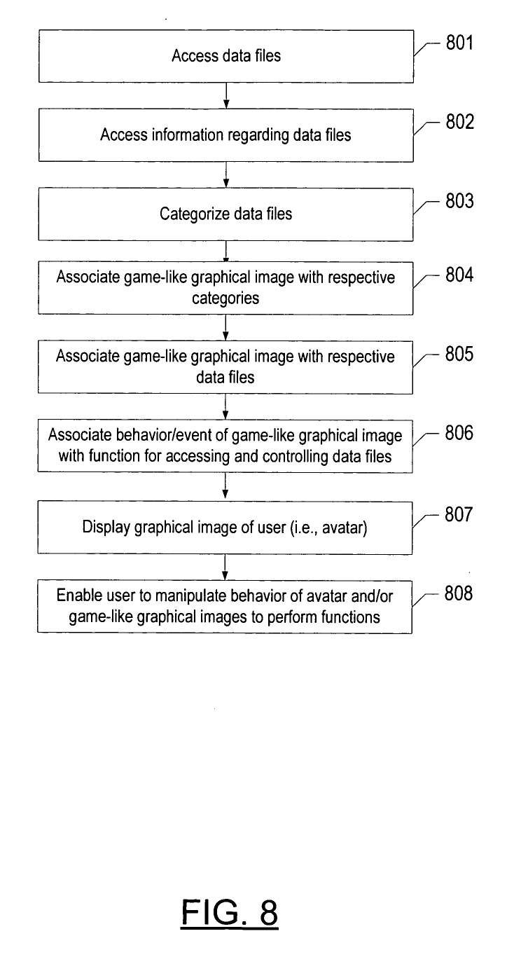

Reference is now made to FIG. 8, which illustrates the steps which may be taken in order to create the game-like GUI for accessing and controlling various data files in accordance with exemplary embodiments of the present invention. The following steps may be performed by either or both the electronic device and the network entity configured to provide data files to the electronic device, for example, as recommendations of music or video files the user may be interested in downloading.

As shown, the process begins at Step 801, where one or more data files are accessed. In one exemplary embodiment, this step may involve the electronic device accessing the various data files, including any audio, video, text or multimedia files, stored on the electronic device memory. Alternatively, or in addition, this step may involve the network entity or the electronic device accessing data files available via the communications network. For example, the network entity, operating as a recommendation engine, may access, via one or more media providers, various audio or video files the engine wishes to recommend to the user.

In Step 802, information describing the various data files may be accessed. For example, in the instance where the data files are audio files, MP3 ID3 meta-data or tags may be accessed. An ID3 tag is a set of meta-data in an MP3, or similar, audio file that describes its contents, including song title, artist, album, year, comment, CD track and genre. ID3 tags are used for searching, as well as for displaying the song title of the audio file being played. ID3 tags reside at the end of the file and comprise 128-bytes divided into six fields (track name, artist name, album name, year, comment and genre).

Other similar descriptive information may likewise be accessed in accordance with various exemplary embodiments of the present invention. For example, metadata relating to music and other media files may also comprise other media content descriptive metadata, such as that described in the MPEG-7 standard. For music, these metadata descriptors may relate, for example, to the melody and timbre of the music. For images, they may relate, for example, to the dominant color or shape. The metadata may also be generated by the user, for example, using the calibration scenarios discussed above, or the metadata may be generated and delivered by the recommendation engine. In one exemplary embodiment, the metadata may describe the mood of the music, such as romantic, danceable, aggressive, or the like.

Using the description of the data files, which may comprise nothing more than a description of what type of data the file contains (i.e., audio, video, text or multimedia), the data files may then be categorized, in Step 803. Categories may be based, for example, on the type of data contained in the file, as in the scenario discussed above wherein trees with musical note-shaped leaves represented audio files, while trees having leaves shaped like miniature cameras represented video files. Alternatively, or in addition, categories may be based on more specific descriptive information (e.g., in the instance of sub-categories), such as mood or musical genre, as was the case discussed above wherein the police officer represented blues music, while the Rastafarian represented reggae.

The next step, Step 804, may be to associate a game element, or game-like graphical image with each category and, in Step 805, with each data file. In addition, in Step 806, a behavior or event associated with the various game-like graphical images may be associated with each function for accessing and controlling the data files and categories. As an example, consider the scenario discussed above with regard to the city having multiple different bars and discotheques. In this scenario, Step 804 may involve assigning the category of country music to a game-like graphical image of a country bar having a DJ and various patrons, perhaps wearing cowboy boots and hats. Steps 805 and 806 may, in turn, involve assigning the graphical image of the DJ in the bar playing a particular song to the audio file corresponding to that song. Likewise, Step 806, may involve assigning the behavior of burning down the country bar with the function of deleting the folder containing all country music files from memory.

In Step 807, the game-like graphical images, including, in some instances, the avatar, are displayed to the user, and the user, in Step 808, is enabled to manipulate the various game-like graphical images in order to perform the various functions related to accessing and controlling the data files.

As noted above, in one exemplary embodiment the foregoing method is performed in relation to data files stored on a user's electronic device, for example, as part of a music collection. In this exemplary embodiment, the data files and gaming programming necessary to implement the game-like GUI may be wholly stored on the electronic device; thus enabling the user to use the game-like GUI regardless of whether he or she has access to a communications network, such as the Internet.

In an alternative embodiment, the game-like GUI may be provided by a network entity acting, for example, as a recommendation engine to provide recommendations for various media files, such as music or video files, that the engine believes the user may be interested in downloading. The user accesses the recommended media files using this game-like GUI, the gaming programming for which, in this instance, may be stored at least partially on the network entity.

### CONCLUSION

As described above and as will be appreciated by one skilled in the art, embodiments of the present invention may be configured as a system, method or network entity. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method of creating a graphical game-like user interface for accessing and controlling one or more data files, said method comprising:
associating a game-like graphical image with respective data files;
associating a behavior of the game-like graphical images with a respective one of a plurality of functions for accessing and controlling the data files; and
enabling a user to manipulate the behavior of the game-like graphical images in order to perform the plurality of functions.

2. The method of claim 1, wherein the game-like graphical images are generated in response to execution of a game, and wherein enabling a user to manipulate the behavior of the game-like graphical images in order to perform the plurality of functions comprises enabling the user to play the game and to select the functions as a result of the game play.

3. The method of claim 1 further comprising:
storing at least a portion of the data files along with corresponding information describing the data files stored.

4. The method of claim 1 further comprising:
accessing, via a communications network, at least a portion of the data files along with corresponding information describing the data files accessed.

5. The method of claim 1 further comprising:
displaying the game-like graphical images associated with respective data files;
displaying an avatar image representing the user; and
enabling the user to manipulate the behavior of the avatar image in order to manipulate the behavior of the game-like graphical images associated with respective data files.

6. The method of claim 1 further comprising:
dividing the data files into one or more categories based at least in part on information describing the data files; and
associating a game-like graphical image with respective categories.

7. The method of claim 1, wherein the data files comprise audio files.

8. The method of claim 7, wherein the audio files comprise meta-data describing one or more attributes of respective audio files, said attributes selected from a group consisting of: song title, song artist, album name and genre.

9. The method of claim 7, wherein the plurality of functions for accessing and controlling the data files are selected from a group consisting of: playing, fast forwarding, rewinding, pausing, stopping, shuffling, renaming, moving, purchasing and deleting the audio file.

10. An electronic device capable of creating a graphical user interface for accessing and controlling one or more data files, said electronic device comprising:
an input device;
a processor in communication with the input device; and
a memory in communication with the processor, said memory storing an application executable by the processor, wherein the application is capable, upon execution, of:
associating a game-like graphical image with respective data files;
associating a behavior of the game-like graphical images with a respective one of a plurality of functions for accessing and controlling the data files; and
enabling a user to manipulate the behavior of the game-like graphical images, using the input device, in order to perform the plurality of functions.

11. The electronic device of claim 10, wherein the game-like graphical images are generated in response to execution of a game, and wherein enabling a user to manipulate the behavior of the game-like graphical images in order to perform the plurality of functions comprises enabling the user to play the game and to select the functions as a result of the game play.

12. The electronic device of claim 10, wherein the memory further stores at least a portion of the data files along with corresponding information describing the data files stored.

13. The electronic device of claim 10, wherein the application is further capable, upon execution, of accessing, via a communications network, at least a portion of the data files, along with corresponding information describing the data files accessed.

14. The electronic device of claim 10 further comprising:
a display in communication with the processor, wherein the application is further capable, upon execution, of:
displaying the game-like graphical images associated with respective data files;
displaying an avatar image representing the user; and
enabling the user to manipulate the behavior of the avatar image, using the input device, in order to manipulate the behavior of the game-like graphical images associated with respective data files.

15. The electronic device of claim 10, wherein the application is further capable, upon execution, of:
dividing the data files into one or more categories based at least in part on information describing the data files; and
associating a game-like graphical image with respective categories.

16. The electronic device of claim 10, wherein the data files are selected from a group consisting of audio, video, text and multimedia files.

17. A network entity capable of providing a game-like graphical user interface through which a user can access and control one or more media files, said network entity comprising:
a processor; and
a memory in communication with the processor, said memory storing an application executable by the processor, wherein the application is capable, upon execution, of:
generating a recommendation of one or more media files for a user; and
creating a game-like graphical user interface through which the user can access and control the recommended media files.

18. The network entity of claim 17, wherein the application is further capable, upon execution, of accessing the media files via a communications network and of transmitting the media files to an electronic device associated with the user.

19. The network entity of claim 17, wherein the application, in order to create the game-like graphical user interface, is further capable, upon execution, of:
associating a game-like graphical image with respective media files;
associating a behavior of the game-like graphical images with respective functions for accessing and controlling the media files; and
enabling said user to manipulate the behavior of the game-like graphical images in order to perform the functions.

20. The network entity of claim 19, wherein the game-like graphical images are generated in response to execution of a game, and wherein enabling a user to manipulate the behavior of the game-like graphical images in order to perform the functions comprises enabling the user to play the game and to select the functions as a result of the game play.

21. The network entity of claim 19, wherein the application is further capable, upon execution, of:
causing the game-like graphical images associated with respective media files to be displayed;
causing an avatar image representing the user to be displayed; and
enabling the user to manipulate the behavior of the avatar image in order to manipulate the behavior of the game-like graphical images associated with respective media files.

22. The network entity of claim 19, wherein the application is further capable, upon execution, of:
dividing the media files into one or more categories based at least in part on information describing the media files; and
associating a game-like graphical image with respective categories.

23. A system for accessing and controlling one or more data files via a game-like graphical user interface, said system comprising:
an electronic device; and
network entity accessible by the electronic device for the purpose of accessing one or more data files, said network entity configured to provide the electronic device with a game-like graphical user interface through which the electronic device is capable of accessing and controlling the data files.

24. The system of claim 23 further comprising:
one or more media providers in communication with the network entity for the purpose of providing the one or more data files to the network entity for accessing by the electronic device.

25. The system of claim 23, wherein the network entity further comprises:
a processor; and
a memory in communication with the processor, said memory storing an application executable by the processor, wherein the application is capable, upon execution, of:
generating a recommendation of one or more data files for a user associated with the electronic device; and
creating the game-like graphical user interface.

26. The system of claim 25, wherein the application, in order to create the game-like graphical user interface, is further capable, upon execution, of:
associating a game-like graphical image with respective data files;
associating a behavior of the game-like graphical images with respective functions for accessing and controlling the data files; and
enabling the user to manipulate the behavior of the game-like graphical images in order to perform the functions.

27. The system of claim 26, wherein the game-like graphical images are generated in response to execution of a game, and wherein enabling a user to manipulate the behavior of the game-like graphical images in order to perform the functions comprises enabling the user to play the game and to select the functions as a result of the game play.

28. The system of claim 26, wherein the application is further capable, upon execution, of:
dividing the data files into one or more categories based at least in part on information describing the data files; and
associating a game-like graphical image with respective categories.

29. A computer program product for creating a game-like graphical user interface for accessing and controlling one or more data files, wherein the computer program product comprises at least one computer-readable storage medium having computer-readable program code portions stored therein, the computer-readable program code portions comprising:
a first executable portion for associating a game-like graphical image with respective data files;
a second executable portion for associating a behavior of the game-like graphical images with a respective one of a plurality of functions for accessing and controlling the data files; and
a third executable portion for enabling a user to manipulate the behavior of the game-like graphical images in order to perform the plurality of functions.

30. The computer program product of claim 29, wherein the game-like graphical images are generated in response to execution of a game, and wherein enabling a user to manipulate the behavior of the game-like graphical images in order to perform the plurality of functions comprises enabling the user to play the game and to select the functions as a result of the game play.

31. The computer program product of claim 29 further comprising:
a fourth executable portion for storing at least a portion of the data files along with corresponding information describing the data files stored.

32. The computer program product of claim 29 further comprising:
a fourth executable portion for accessing, via a communications network, at least a portion of the data files along with corresponding information describing the data files accessed.

33. The computer program product of claim 29 further comprising:
a fourth executable portion for displaying the game-like graphical images associated with respective data files;
a fifth executable portion for displaying an avatar image representing the user; and
a sixth executable portion for enabling the user to manipulate the behavior of the avatar image in order to manipulate the behavior of the game-like graphical images associated with respective data files.

34. The computer program product of claim 29 further comprising:
a fourth executable portion for dividing the data files into one or more categories based at least in part on the information describing the data files; and
a fifth executable portion for associating a game-like graphical image with respective categories.

35. The computer program product of claim 29, wherein the data files comprise audio files.

36. The computer program product of claim 35, wherein the information describing the data files comprises meta-data describing one or more attributes of respective audio files, said attributes selected from a group consisting of: song title, song artist, album name and genre.

37. The computer program product of claim 35, wherein the plurality of functions for accessing and controlling the data files are selected from a group consisting of: playing, fast forwarding, rewinding, pausing, stopping, shuffling, renaming, moving, purchasing and deleting the audio file.

38. The electronic device of claim 10, wherein one of the plurality of functions for accessing and controlling the data files comprises purchasing at least one of the data files.

39. The network entity of claim 17, wherein the application is further capable, upon execution, of:
enabling the user to purchase at least one of the media files.

40. The system of claim 26, wherein one of the functions for accessing and controlling the data files comprises purchasing at least one of the data files.
